(19) United States
(12) Patent Application Publication
(10) Pub. No.: US 2012/0013474 A1
(43) Pub. Date: Jan. 19, 2012

(54) METHOD FOR INFORMING A USER OF A POSSIBILITY TO COMPLETE THE EXECUTION OF A PROCESS IN A COMPUTING DEVICE

(76) Inventor: Jean-Baptiste MARTINOLI, St-Anaclet-de-Lessard (CA)

(21) Appl. No.: 13/007,119

(22) Filed: Jan. 14, 2011

Related U.S. Application Data
(60) Provisional application No. 61/365,011, filed on Jul. 16, 2010.

(51) Int. Cl. G08B 21/00

(52) U.S. Cl. 340/636.1

(57) ABSTRACT

A method for informing a user of the possibility to execute a given process using existing resources is disclosed, the method comprising selecting a process to be executed, receiving information indicative of a level of battery charge, determining if said level of battery charge is sufficient for completing the execution of the selected process and providing information indicative of the determination to a user.

### CROSS-REFERENCE AND RELATION APPLICATIONS

This patent application claims priority of US Provisional patent application No. 61/365,011 entitled “Method for informing a user of a possibility to complete the execution of a process” that was filed on Jul. 16, 2010, the specification of which is hereby incorporated by reference.

### FIELD OF THE INVENTION

The invention relates to the field of computing devices. More precisely, this invention pertains to a method for informing a user of a possibility to complete the execution of a process in a computing device.

### BACKGROUND OF THE INVENTION

Portable electronic devices often suffer from limitations associated with their available resources.

A user may for instance execute a program and then discover that the program will not be fully executed due to a lack of remaining resources which is a drawback.

While in some instances the fact that the program is not fully executed does not cause a prejudice per se to the user or the portable electronic device, it will be appreciated by the skilled addressee that in some other instances the fact that the program is not fully executed may cause a prejudice to the user or the portable electronic device which is a another drawback.

There is therefore a need for a method that will overcome at least one of the above-identified drawbacks.

Features of the invention will be apparent from review of the disclosure, drawings and description of the invention below.

### BRIEF SUMMARY

The invention provides a method for informing a user of the possibility to execute a given process using existing resources, the method comprising selecting a process to be executed, receiving information indicative of a level of battery charge, determining if said level of battery charge is sufficient for completing the execution of the selected process and providing information indicative of said determination to a user.

In accordance with an embodiment the process to be executed is selected by a user, and the information indicative of the determination is provided to the user.

In yet another embodiment, the selecting of a process to be executed comprises executing an application.

In yet another embodiment, the information indicative of a level of battery charge is received from an operating system application programming interface (API).

In another embodiment, the information indicative of a level of battery charge comprises a percentage of remaining available battery.

In yet another embodiment, the information indicative of a level of battery charge comprises estimated time of battery life and estimated time to full charge when plugged.

In yet another embodiment, the determining to find out if the level of battery charge is sufficient for completing the execution of the selected process comprises comparing an indication of an estimated time to complete the execution of the process to execute with an indication of a remaining life time of the battery.

In yet another embodiment, the indication of an estimated time to complete the execution of the process to execute is obtained from an application associated with the process.

In another embodiment, the indication of an estimated time to complete the execution of the process to execute is determined using statistical models.

In yet another embodiment, the indication of a remaining life time of the battery is obtained using a lookup table indicating a corresponding remaining life time for a given information indicative of a battery charge.

In yet another embodiment, the determining to find out if the level of battery charge is sufficient for completing the execution of the selected process is performed using a statistical model with fragmentation of battery level historical data.

In yet another embodiment, the providing of the information indication of the determination comprises providing a message if the level of battery is insufficient for executing the process to be executed.

In yet another embodiment, the message comprises at least one of a visual message and an audio message.

In yet another embodiment, the message comprises a warning pop up message.

In another embodiment, the method further comprises providing the information indicative of the determination to another process.

In yet another embodiment, the other process shuts down a third process.

In yet another embodiment, the method further comprises stopping the selected process if the level of battery charge is insufficient for completing the execution of the selected process.

In accordance with another embodiment, there is provided a computer-readable storage medium storing computer-executable instructions which, when executed, cause a computing device to perform a method for informing a user of the possibility to execute a given process using existing resources, the method comprising selecting a process to be executed; receiving information indicative of a level of battery charge; determining if the level of battery charge is sufficient for completing the execution of the selected process and providing information indicative of the determination to a user.

In accordance with another embodiment, there is provided a computing device, comprising a display device; one or more central processing units; a memory comprising an application; and one or more programs, wherein the one or more programs are stored in the memory and configured to be executed by the one or more central processing units, the one or more programs including: instructions for selecting a process to be executed; instructions for receiving information indicative of a level of battery charge; instructions for determining if the level of battery charge is sufficient for completing the execution of the selected process and instructions for providing information indicative of the determination to a user.

A process is intended to mean a computer program or an instance of a program running concurrently with other programs.

### BRIEF DESCRIPTION OF THE DRAWINGS

In order that the invention may be readily understood, embodiments of the invention are illustrated by way of example in the accompanying drawings.

FIG. 1 is a block diagram of an embodiment of a computing device in which an embodiment of the method for informing a user of a possibility to complete the execution of a process may be implemented;

FIG. 2 is a flowchart which shows an embodiment of a method for informing a user of a possibility to complete the execution of a process in a computing device; and

FIG. 3 is a diagram which shows an embodiment of a graphics user interface displayed in a computing device in which an embodiment of the method for informing a user of a possibility to complete the execution of a process may be executed.

Further details of the invention and its advantages will be apparent from the detailed description included below.

### DETAILED DESCRIPTION

In the following description of the embodiments, references to the accompanying drawings are by way of illustration of an example by which the invention may be practiced. It will be understood that other embodiments may be made without departing from the scope of the invention disclosed.

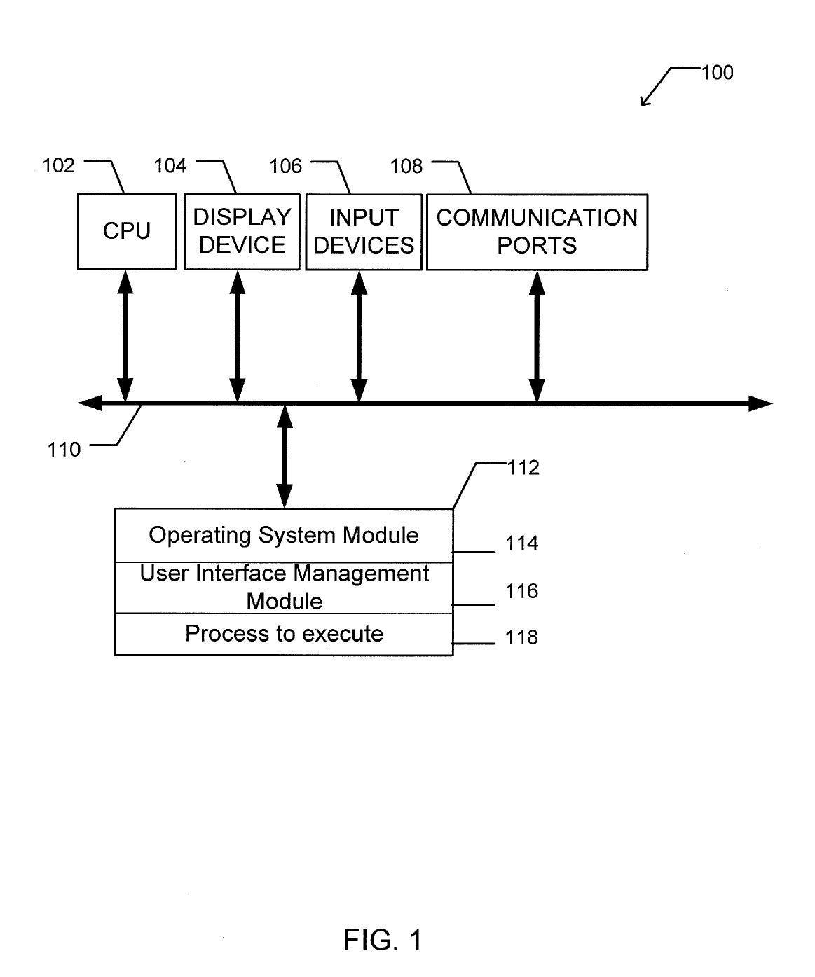

Now referring to FIG. 1, there is shown an embodiment of a computing device 100 in which an embodiment of the method for informing a user of a possibility to complete the execution of a process may be implemented.

In this embodiment the computing device 100 comprises one or more Central Processing Unit (CPU) 102, a display device 104, input devices 106, communication ports 108, a data bus 110 and a memory 112.

The Central Processing Unit 102, the display device 104, the input devices 106, communication ports 108 and the memory 112 are connected together using the data bus 110.

In one embodiment the computing device 100 is the ExoPC™ manufactured by Pegatron. Still in this embodiment the Central Processing Unit 102

is Atom Pineview-M N450 manufactured by Intel™, running at 1.66 GHz and supporting 64 bits.

Still in this embodiment, the display device 104 comprises a touch screen panel having 11.6-inch width and a resolution of 1366×768 pixels with 135 pixels per inch. The touch screen panel uses a multipoint capacitive technology known to the ones skilled in the art. The display device 104 further comprises a GMA500 graphics card manufactured by Intel™.

The input devices 106 are used for providing data to the computing device 100.

In this embodiment, the input devices 106 comprise an accelerometer, a microphone, a luminosity sensor and a camera. The skilled addressee will appreciate that various other embodiments for the input devices 106 may alternatively be provided.

The communications ports 108 are used for enabling a communication of the computing device 100 with other devices.

In this embodiment, the communication ports 108 comprise a WIFI 802.11 b/g/n port, a Bluetooth 2.1+EDR port, two USB 2.0 ports, a SD/SDHC card reader and a mini HDMI port. The skilled addressee will again appreciate that various other embodiments may be provided for the communication ports 108.

The memory 112 is used for storing data.

In this embodiment, the memory 112 comprises a Solid State Drive (SSD) having a capacity of either 32 or 64 GB.

More precisely and still in this embodiment, the memory 112 comprises, inter alia, an operating system module 114. The operating system module 114 is Windows 7™ Home Premium Edition manufactured by Microsoft™.

The memory 112 further comprises a user interface management module 116. The user interface management module 116 is used for managing the user interface of the computing device 100. It will be appreciated that the method for informing a user of a possibility to complete the execution of a process may be implemented within the user interface management module 116. In such embodiment, the user interface management module 116 would comprise for instance instructions for selecting a process to be executed; instructions for receiving information indicative of a level of battery charge; instructions for determining if the level of battery charge is sufficient for completing the execution of the selected process and instructions for providing information indicative of the determination to a user.

Alternative embodiments may be possible. For instance, the method for informing a user of a possibility to complete the execution of a process may be implemented within the operating system module 114.

The memory 112 further comprises a process to execute 118. It will be appreciated that the process to execute 118 may be of various types. In fact, it should be understood that a process is intended to mean a computer program or an instance of a program running concurrently with other programs. It will be appreciated that for instance the process to execute may be a movie to watch, in such embodiment, the process to execute does not solely depend on an application but on a combination of an application and data.

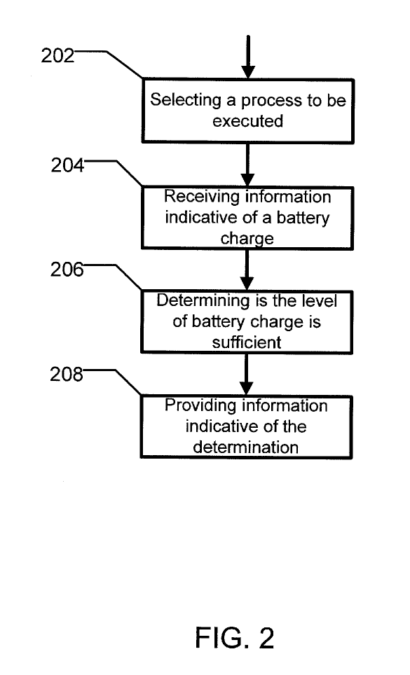

Now referring to FIG. 2, there is shown an embodiment of a method 200 for informing a user of a possibility to complete the execution of a process.

According to processing step 202 a process to be executed is selected.

In one embodiment, the process to be executed is selected by a user. It will be appreciated that a process may comprise one of a computer program and an instance of a program running concurrently with other programs.

Accordingly, the skilled addressee will appreciate that in this embodiment, the process to be executed may comprise executing a given application.

In many instances, the execution of an application depends on data associated with the application. For instance, in the case of an application for watching a movie, the execution of the application depends on the movie per se. In the case of an application for defragmenting a hard drive, the execution depends on the size and the structure of the data in the hard drive.

According to processing step 204 information indicative of a battery charge is received.

It will be appreciated by the skilled addressee that the information indicative of a battery charge may be received from various means such as the operating system application programming interface for instance.

In one embodiment the information indicative of a battery charge may comprise a percentage of remaining available battery. Alternatively the information indicative of a battery charge may comprise estimated time of battery life, estimated time to full charge when plugged.

In a preferred embodiment, the information indicative of a battery charge is made of estimated time of battery life, estimated time to full charge when plugged and is obtained using an API of the operating system module.

According to processing step 206 a determination is performed to find out if the level of battery is sufficient.

It will be appreciated that in a preferred embodiment the determination is performed by comparing an indication of an estimated time to complete the execution of the process to execute with an indication of a remaining life time of the battery.

The indication of an estimated time to complete the execution of the process to execute may be obtained using various methods. For instance, in the case where the process to execute comprises watching a movie, the indication of an estimated time to complete the execution of the process to execute may be obtained directly from an application associated with the process.

Alternatively the indication of an estimate time to complete the execution of the process may be determined indirectly using statistical models (e.g. average of previous executions, processor load).

Similarly, the indication of a remaining life time of the battery may be obtained using various methods. For instance, the indication of a remaining life time may be obtained by accessing a lookup table indicating a corresponding remaining life time for a given information indicative of a battery charge.

Alternatively, the indication of a remaining life time of the battery may be obtained using formulae taking into considerations current applications being executed, etc.

In a preferred embodiment, the determination is performed by a statistical model with fragmentation of the battery level historical data for better accuracy.

According to processing step 208, information indicative of the determination is provided.

It will be appreciated by the skilled addressee that the information indicative of the determination may be provided according to various embodiments.

It will be appreciated that in one embodiment a message may be provided if the level of battery is insufficient for executing the process to be executed. The message may comprise at least one of a visual and an audio message.

In a preferred embodiment, the information indicative of the determination is provided to the user using a warning pop up message. Such warning pop up message is used to warn the user that the process to be executed may not be fully executed due to the existing battery charge. The warning pop up message may further invite the user to plug a power cord in order to recharge the battery.

In an alternative embodiment, the information indicative of the determination is provided to another process, such as a task manager for instance. The other process may then use the information indicative of the determination to take pertinent measures such as shutting down a third process (other energy consuming processes).

Alternatively, the process to be executed may be stopped if the level of battery is insufficient for executing it.

In an alternative embodiment, only applications that may be executed may be displayed to the user, other ones that will not be able to be executed can be removed from the sight of the user.

The skilled addressee will appreciate that the embodiment disclosed herein is of great advantage since it readily enable a user to know if what he is intended to use will be able to be executed or not which is of great advantage.

Such embodiment will therefore limit/suppress frustration associated with the incomplete execution of a process that cannot be later completed due to a lack of resources.

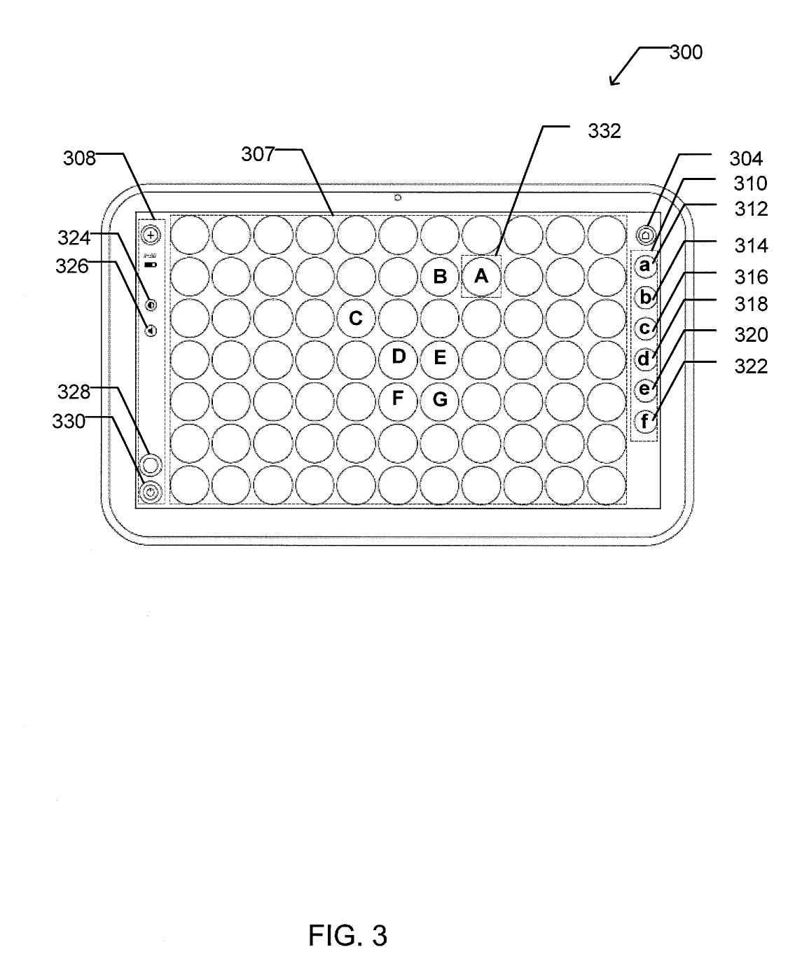

Now referring to FIG. 3, there is shown an embodiment of a graphics user interface 300 of a computing device 100 in which an embodiment of the method for informing a user of a possibility to complete the execution of a process may be executed.

The graphics user interface 300 comprises a left hand portion 308, a central portion 307 and a right hand portion comprising a home button 304 and an display application portion 310.

The left hand portion 308 comprises a plurality of icons each used for a specific function. For instance and in the embodiment shown in FIG. 3, icon 324 is used for adjusting luminosity and contrast, icon 326 is used for controlling the volume of the sound output, icon 328 is used for starting a menu and icon 330 is used for starting/stopping the computing device.

The central portion is used for displaying a plurality of applications installed in the computing device. In the embodiment shown in FIG. 3, applications A, B, C, D, E, F and G are available. For instance, application A can be launched by touching icon 332.

It will be appreciated that each of the available circles can host an icon representative of an application available for execution. Moreover, it will be appreciated that a background image, not shown, may be provided in background of the plurality of circles. In an alternative embodiment, geometric shapes other than a circle may be used for receiving icons representative of an application.

The right hand portion comprises a home button 304 for accessing a home menu comprising all the icons of available applications.

The display application portion 310 comprises a plurality of icons representative of applications that are currently being executed.

For instance, icon 312 is representative of application A that is being currently executed, icon 314 is representative of application B that is being currently executed, icon 316 is representative of application C that is being currently executed, icon 318 is representative of application D that is being currently executed, icon 320 is representative of application E that is being currently executed and icon 322 is representative of application F that is being currently executed.

The skilled addressee will appreciate that it is possible to access a given application being executing by touching the icon representative of the application sought. For instance, a user can access application F by touching icon 322.

A user may therefore easily toggle between applications using the display application portion 310.

It will be appreciated that the method disclosed herein may be implemented according to various embodiments and using various programming languages known to the skilled addressee.

Also, it will be appreciated that a computer-readable storage medium may be provided for storing computer-executable instructions. Such computer-executable instructions would cause a computing device, when executed, to perform a method for informing a user of the possibility to execute a given process using existing resources, the method comprising selecting a process to be executed; receiving information indicative of a level of battery charge; determining if the level of battery charge is sufficient for completing the execution of the selected process and providing information indicative of the determination to a user.

Although the above description relates to a specific preferred embodiment as presently contemplated by the inventor, it will be understood that the invention in its broad aspect includes mechanical and functional equivalents of the elements described herein.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

1. A method for informing a user of the possibility to execute a given process using existing resources, the method comprising:
selecting a process to be executed;
receiving information indicative of a level of battery charge;
determining if said level of battery charge is sufficient for completing the execution of the selected process; and
providing information indicative of said determination to a user.

2. The method as claimed in claim 1, wherein said process to be executed is selected by a user, further wherein the information indicative of said determination is provided to the user.

3. The method as claimed in claim 1, wherein the selecting of a process to be executed comprises executing an application.

4. The method as claimed in claim 1, wherein the information indicative of a level of battery charge is received from an operating system application programming interface (API).

5. The method as claimed in claim 1, wherein the information indicative of a level of battery charge comprises a percentage of remaining available battery.

6. The method as claimed in claim 1, wherein the information indicative of a level of battery charge comprises estimated time of battery life and estimated time to full charge when plugged.

7. The method as claimed in claim 1, wherein the determining to find out if said level of battery charge is sufficient for completing the execution of the selected process comprises comparing an indication of an estimated time to complete the execution of the process to execute with an indication of a remaining life time of the battery.

8. The method as claimed in claim 7, wherein the indication of an estimated time to complete the execution of the process to execute is obtained from an application associated with the process.

9. The method as claimed in claim 7, wherein the indication of an estimated time to complete the execution of the process to execute is determined using statistical models.

10. The method as claimed in claim 7, wherein the indication of a remaining life time of the battery is obtained using a lookup table indicating a corresponding remaining life time for a given information indicative of a battery charge.

11. The method as claimed in claim 1, wherein the determining to find out if said level of battery charge is sufficient for completing the execution of the selected process is performed using a statistical model with fragmentation of battery level historical data.

12. The method as claimed in claim 1, wherein the providing of the information indication of the determination comprises providing a message if the level of battery is insufficient for executing the process to be executed.

13. The method as claimed in claim 12, wherein the message comprises at least one of a visual message and an audio message.

14. The method as claimed in claim 12, wherein the message comprises a warning pop up message.

15. The method as claimed in claim 1, further comprising providing the information indicative of the determination to another process.

16. The method as claimed in claim 15, further comprising said another process shutting down a third process.

17. The method as claimed in claim 1, further comprising stopping said selected process if said level of battery charge is insufficient for completing the execution of the selected process.

18. A computer-readable storage medium storing computer-executable instructions which, when executed, cause a computing device to perform a method for informing a user of the possibility to execute a given process using existing resources, the method comprising:
selecting a process to be executed;
receiving information indicative of a level of battery charge;
determining if said level of battery charge is sufficient for completing the execution of the selected process; and
providing information indicative of said determination to a user.

19. A computing device, comprising:
a display device;
one or more central processing units;
a memory comprising an application; and
one or more programs, wherein the one or more programs are stored in the memory and configured to be executed by the one or more central processing units, the one or more programs including:
instructions for selecting a process to be executed;
instructions for receiving information indicative of a level of battery charge;
instructions for determining if said level of battery charge is sufficient for completing the execution of the selected process; and
instructions for providing information indicative of said determination to a user.
